(19) United States
(12) Patent Application Publication
(10) Pub. No.: US 2017/0026883 A1
(43) Pub. Date: Jan. 26, 2017

(54) METHOD OF, AND ARRANGEMENT FOR, ENHANCING ROAMING PERFORMANCE OF A MOBILE CLIENT THAT IS ROAMING BETWEEN ACCESS POINTS CONNECTED TO A DISTRIBUTION SYSTEM

(71) Applicant: SYMBOL TECHNOLOGIES, LLC, LINCOLNSHIRE, IL (US)

(72) Inventors: RAJIV SHIRIRANG JOSHI, BANGALORE (IN); YADUKISHORE KODICHERLA, BANGALORE (IN); RAJ KIRAN, SAN JOSE, CA (US); SANDEEP RAMAKRISHNAN, BANGALORE (IN)

(21) Appl. No.: 14/806,738

(22) Filed: Jul. 23, 2015

(51) Int. Cl. H04W 36/08; H04W 36/36; H04W 36/00

(52) U.S. Cl. CPC H04W 36/08; H04W 36/0011; H04W 36/0061; H04W 36/36

(57) ABSTRACT

Roaming performance of a mobile client exchanging data with a current access point (AP) is enhanced by discovering candidate APs available for roaming, combining information from the candidate APs to construct an aggregated fast transition (FT) request frame, and sending the aggregated FT request frame to an aggregated FT handler, which sends individual FT request messages to each candidate AP, receives individual FT response messages from each candidate AP, combines the individual FT response messages to construct an aggregated FT response frame, and sends the aggregated FT response frame to the client. The client selects a target AP from the candidate APs, constructs a reassociation request frame based on the aggregated FT response frame, sends the reassociation request frame to the target AP, receives a reassociation response frame constructed by the target AP based on the aggregated FT request and response frames, and exchanges data with the target AP.

### BACKGROUND OF THE INVENTION

The present invention relates generally to a method of, and an arrangement for, enhancing roaming performance of a mobile client that is roaming between access points (APs) connected to a distribution system (DS), and, more particularly, to increasing the reliability, the efficiency, the quality, and the consistency of the roaming performance of the client wanting to roam between a current AP with which the client is currently exchanging data, to a target AP to which the client wishes to exchange data after roaming, especially in delay-sensitive communications applications, such as Internet Protocol (IP) networks over which voice and/or video (VoIP) are carried.

In accordance with the Institute of Electrical and Electronics Engineers (IEEE) 802.11 original standard of specifications for wireless local area network (LAN) technology, it was known for a mobile client, e.g., a smartphone, a tablet, a laptop or portable computer, a personal digital assistant, a wearable communications device, a handheld and/or vehicular radio, or an analogous supplicant device, to exchange data with an AP, normally a wireless router, only after sending an authentication request frame to the AP, then receiving an authentication response frame from the AP, then sending an association request frame to the AP, and then receiving an association response frame from the AP. This was followed by an IEEE 802.1X authentication and/or four-way handshake involving key derivation, only after which the data exchange was deemed complete and secure. When the client moved and was in the coverage range of another AP, all of the above frame exchanges had to be repeated. This handshaking overhead procedure was time-consuming, sometimes approaching one-half a second or more in duration, and was not well suited for VoIP applications where a short roaming handoff time, e.g., on the order of fifty milliseconds, between APs was generally considered the highest amount of delay that could be introduced and tolerated in a voice call or video session.

To shorten the roaming handoff time, the IEEE 802.11 standard was amended to the IEEE 802.11r standard, which specified fast, basic service set (BSS), transitions (FT) between APs without requiring the separate IEEE 802.1X authentication and/or extensible authentication protocol (EAP) over LAN (EAPoL) authentication, thereby eliminating some of the handshaking overhead, and in shortening the roaming handoff time, after a target AP, to which the client wished to exchange data after roaming, was found. In accordance with the IEEE 802.11r standard of FT roaming over the DS, the client had to first send an individual FT request frame to each candidate AP available for roaming for the purpose of key derivation, typically one after another, over a wireless connection, and then by separately receiving an individual FT response frame from each candidate AP, typically one after another, over the wireless connection, thereby increasing the roaming handoff time until keys with the target AP were derived. This process of exchanging individual frames with each candidate AP was complex and often time-consuming, because the client also had to sometimes accommodate repeats, retries, and timeouts of at least some of the APs. In addition, the wireless sending and receiving of FT request frames and FT response frames were subject to frame or data packet loss in the air. This packet loss increased when multiple FT request frames and multiple FT response frames were being sent and received over the air. All of these factors led to poor performance, and sometimes even failure, by the client to perform IEEE 802.11r FT roaming over the DS, thereby causing the roaming performance to be unreliable, inefficient, low quality, and poor in consistency.

Accordingly, there is a need to enhance roaming performance of a mobile client that is roaming between APs and, more particularly, to increase the reliability, the efficiency, the quality, and the consistency of the roaming performance.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a circuit topology of an arrangement for enhancing roaming performance of a mobile client that is roaming between APs connected to a DS in accordance with the present disclosure.

FIG. 2 is a connection and time sequence diagram of the arrangement of FIG. 1 in accordance with the present disclosure.

FIG. 3 is a diagram depicting the format of an aggregated FT request/response frame generated in accordance with the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The method and arrangement components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of the present disclosure relates to a method of enhancing roaming performance of a mobile client wanting to roam away from a current access point (AP) with which the client is currently exchanging data, over a distribution system (DS) having a plurality of other APs interconnected with the current AP. The method is performed by the client discovering candidate APs that are available for roaming from among the other APs, by the client combining information from the candidate APs to construct an aggregated fast transition (FT) request frame, and by the client sending the aggregated FT request frame to an aggregated FT handler over a wireless connection. The aggregated FT handler sends individual FT request messages based on the aggregated FT request frame to each candidate AP over the DS, receives individual FT response messages from each candidate AP over the DS, combines the individual FT response messages to construct an aggregated FT response frame, and sends the aggregated FT response frame to the client over the wireless connection. The client also selects a target AP from the candidate APs, constructs a reassociation request frame based on the aggregated FT response frame, sends the reassociation request frame to the target AP, receives a reassociation response frame constructed by the target AP based on both the aggregated FT request frame and the aggregated FT response frame, and exchanges data with the target AP. Preferably, the aggregated FT handler is located in the current AP, but could also be located in any of the other APs, or in a real or virtual controller in the DS, or in the DS itself, or in the cloud.

Still another aspect of the present disclosure relates to an arrangement for enhancing roaming performance. The arrangement includes a distribution system (DS) having a plurality of interconnected access points (APs), a mobile client currently exchanging data with one of the APs (current AP), and an aggregated FT handler. The client discovers candidate APs that are available for roaming from among others of the APs, combines information from the candidate APs to construct an aggregated fast transition (FT) request frame, and sends the aggregated FT request frame to the aggregated FT handler over a wireless connection. The aggregated FT handler receives the aggregated FT request frame from the client, sends individual FT request messages based on the aggregated FT request frame to each candidate AP over the DS, receives individual FT response messages from each candidate AP over the DS, combines the individual FT response messages to construct an aggregated FT response frame, and sends the aggregated FT response frame to the client over the wireless connection. The client also selects a target AP from the candidate APs, constructs a reassociation request frame based on the aggregated FT response frame, sends the reassociation request frame to the target AP, receives a reassociation response frame constructed by the target AP based on both the aggregated FT request frame and the aggregated FT response frame, and exchanges data with the target AP.

In accordance with the present disclosure, the client need no longer separately send an individual FT request frame over a wireless connection to each available AP, one after another, and separately receive an individual FT response frame over the wireless connection from each available AP, one after another. Instead, an aggregated FT request frame, and preferably a single such request frame, is constructed and sent over the wireless connection, and an aggregated FT response frame, and preferably a single such response frame, is constructed and sent over the wireless connection. The aforementioned packet loss problem is greatly reduced since multiple FT request frames and multiple FT response frames are not sent over the air. The client can now readily perform IEEE 802.11r FT roaming over the DS in a rapid, reliable, efficient, high quality, and consistent manner.

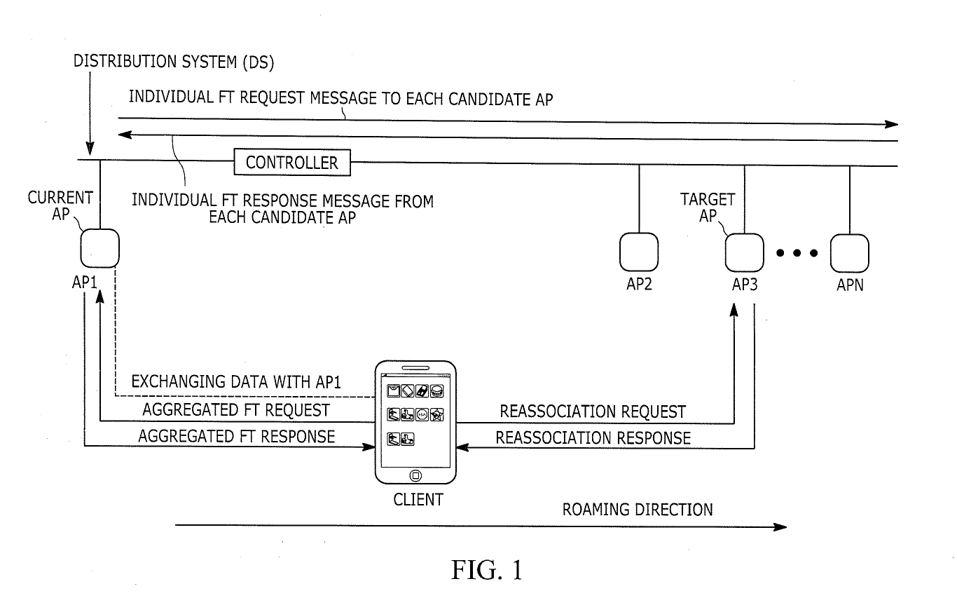

Turning now to FIG. 1 of the drawings, an arrangement for enhancing roaming performance includes a wired or wireless, distribution system (DS) having a plurality of interconnected access points (APs), which are separately identified as AP1, AP2, AP3, . . . , APN, where N is any whole number, a mobile client currently exchanging data with one (e.g., AP1) of the APs, hereinafter sometimes referred to as the current AP, and a real or virtual controller interconnected to all the APs. The client is shown in FIG. 1 as a tablet, but it will be understood that other supplicant devices, such as a smartphone, a laptop or portable computer, a personal digital assistant, a wearable communications device, or a handheld and/or vehicular radio, could also be employed. As shown, the client in FIG. 1 is currently exchanging data with the current AP, and wishes to roam along the illustrated roaming direction to another (e.g., AP3) of the APs, hereinafter sometimes referred to as the target AP, in order to exchange data with the target AP after roaming. Each AP is a wireless router and acts as a bridge to the DS.

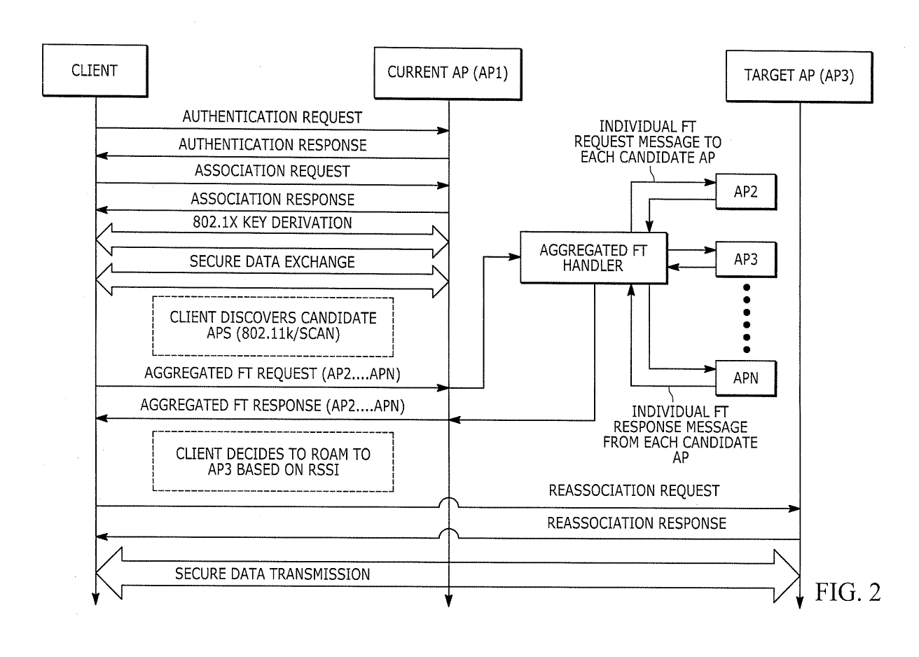

A connection and time sequence diagram is depicted in FIG. 2 to explain the operation of the arrangement of FIG. 1. The client, the current AP, and the target AP are arranged along the top of FIG. 2, and the various functions performed by each are set forth as one proceeds down the figure toward the bottom of FIG. 2. Thus, in accordance with the IEEE 802.11 standard, the client is currently exchanging data with the current AP, because the client had already sent an authentication request frame to the current AP, then had already received an authentication response frame from the current AP, then had already sent an association request frame to the current AP, and then had already received an association response frame from the current AP. In addition, keys in accordance with the IEEE 802.1X standard were derived and exchanged between the client and the current AP, thereby enabling the data to be securely exchanged.

In accordance with the present disclosure, before the client decides to roam away from the current AP, the following steps are performed. First, the client discovers candidate APs that are available for roaming from among the other APs. This can be accomplished by having the client request a neighbor list of the other APs that neighbor the current AP in accordance with the IEEE 802.11k standard, or by having the client scan the other APs, either actively by sending out probe requests to the other APs and by receiving probe responses from the other APs, or passively by listening for beacons from the other APs.

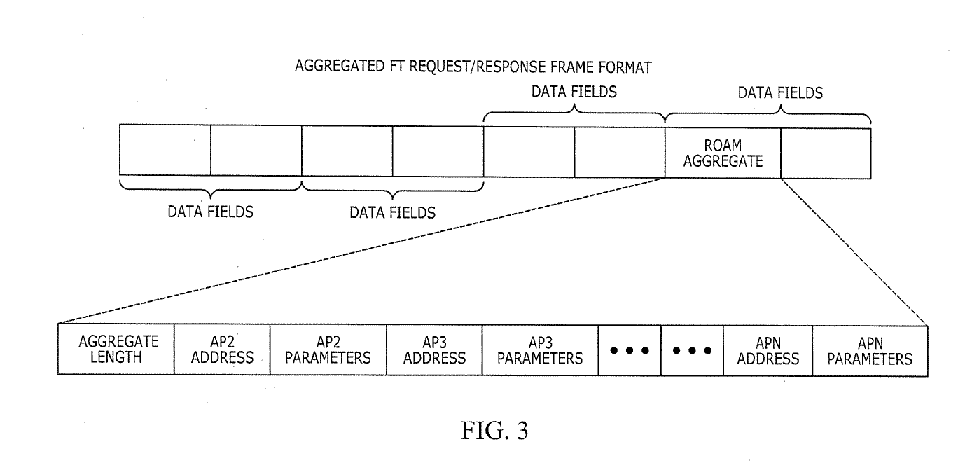

Next, the client combines information from the candidate APs to construct an aggregated fast transition (FT) request frame, and sends the aggregated FT request frame, preferably as a single such frame, to an aggregated FT handler over a wireless connection. The aggregated FT handler receives the aggregated FT request frame from the client, sends individual FT request messages based on the aggregated FT request frame to each candidate AP over the DS, receives individual FT response messages from each candidate AP over the DS, combines the individual FT response messages to construct an aggregated FT response frame, and sends the aggregated FT response frame, preferably as a single such frame, to the client over the wireless connection. The formatting of each such aggregated FT request/response frame is described below in connection with FIG. 3. The aggregated FT handler depicted in FIG. 2 is not necessarily a separate device, and is preferably located in the current AP, as depicted in FIG. 1. The aggregated FT handler, however, could also be located elsewhere, for example, in any of the other APs, or in a real or virtual controller in the DS, or in the DS itself, or in the cloud.

The above steps have all been performed prior to the client deciding to roam. The client selects which of the other candidate APs is best suited to roam to. This selection can be based on various factors. For example, if the client determines that AP3 has the highest received signal strength indication (RSSI) from among all of the candidate APs, then the client will select AP3 as the target AP. As another example, this selection can be based on the aggregated FT response frame. As shown in FIG. 2, the client can then, in accordance with IEEE 802.11r FT over the DS roaming, construct a reassociation request frame based on the aggregated FT response frame, send the reassociation request frame to the target AP, receive a reassociation response frame constructed by the target AP based on both the aggregated FT request frame and the aggregated FT response frame, and exchange data with the target AP, thereby completing the roaming procedure.

Turning now to FIG. 3, each of the aggregated FT request frame and the FT response frame is formatted in one or more packets with multiple data fields, at least one of the fields being designated as a roam aggregate field containing information about all the candidate APs (AP2, AP3, . . . , APN). The information includes, among other things, the address and parameters of each one of the candidate APs (AP2, AP3, . . . , APN).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of enhancing roaming performance of a mobile client wanting to roam away from a current access point (AP) with which the client is currently exchanging data, over a distribution system (DS) having a plurality of other APs interconnected with the current AP, the method comprising:
the client discovering candidate APs that are available for roaming from among the other APs;
the client combining information from the candidate APs to construct an aggregated fast transition (FT) request frame, and sending the aggregated FT request frame to an aggregated FT handler over a wireless connection;
the aggregated FT handler sending individual FT request messages based on the aggregated FT request frame to each candidate AP over the DS, and receiving individual FT response messages from each candidate AP over the DS;
the aggregated FT handler combining the individual FT response messages to construct an aggregated FT response frame, and sending the aggregated FT response frame to the client over the wireless connection;
the client selecting a target AP from the candidate APs; and
the client constructing a reassociation request frame based on the aggregated FT response frame, sending the reassociation request frame to the target AP, receiving a reassociation response frame constructed by the target AP based on both the aggregated FT request frame and the aggregated FT response frame, and exchanging data with the target AP.

2. The method of claim 1, wherein the discovering of the candidate APs is performed by the client requesting a neighbor list of the candidate APs that neighbor the current AP.

3. The method of claim 1, wherein the discovering of the candidate APs is performed by the client scanning the DS for the candidate APs.

4. The method of claim 1, wherein the sending of the aggregated FT request frame to the current AP is performed by sending only a single aggregated FT request frame, and wherein the sending of the aggregated FT response frame to the client is performed by sending only a single aggregated FT response frame.

5. The method of claim 1, and formatting each of the aggregated FT request frame and the aggregated FT response frame with multiple data fields, at least one the fields containing information about all the candidate APs.

6. The method of claim 1, and locating the aggregated FT handler in the current AP.

7. The method of claim 1, and locating the aggregated FT handler in a controller of the DS.

8. The method of claim 1, and locating the aggregated FT handler in the DS.

9. An arrangement for enhancing roaming performance, the arrangement comprising:
a distribution system (DS) having a plurality of interconnected access points (APs);
a mobile client currently exchanging data with one of the APs (current AP), and operative for discovering candidate APs that are available for roaming from among others of the APs, for combining information from the candidate APs to construct an aggregated fast transition (FT) request frame, and for sending the aggregated FT request frame over a wireless connection;
an aggregated FT handler operative for receiving the aggregated FT request frame from the client, for sending individual FT request messages based on the aggregated FT request frame to each candidate AP over the DS, for receiving individual FT response messages from each candidate AP over the DS, for combining the individual FT response messages to construct an aggregated FT response frame, and for sending the aggregated FT response frame to the client over the wireless connection; and
the client being further operative for selecting a target AP from the candidate APs, constructing a reassociation request frame based on the aggregated FT response frame, sending the reassociation request frame to the target AP, receiving a reassociation response frame constructed by the target AP based on both the aggregated FT request frame and the aggregated FT response frame, and exchanging data with the target AP.

10. The arrangement of claim 9, wherein the client discovers the candidate APs by requesting a neighbor list of the candidate APs that neighbor the current AP.

11. The arrangement of claim 9, wherein the client discovers the candidate APs by scanning the DS for the candidate APs.

12. The arrangement of claim 9, wherein the client sends only a single aggregated FT request frame to the aggregated FT handler, and wherein the aggregated FT handler sends only a single aggregated FT response frame to the client.

13. The arrangement of claim 9, wherein each of the aggregated FT request frame and the aggregated FT response frame is formatted with multiple data fields, at least one of the fields containing information about all the candidate APs.

14. The arrangement of claim 9, wherein the aggregated FT handler is located in the current AP.

15. The arrangement of claim 9, wherein the aggregated FT handler is located in a controller of the DS.

16. The arrangement of claim 9, wherein the aggregated FT handler is located in the DS.
